(19) United States
(12) Patent Application Publication
(10) Pub. No.: US 2015/0008651 A1
(43) Pub. Date: Jan. 8, 2015

(54) SEALING ARRANGEMENT

(71) Applicants: DENSO CORPORATION, Kariya-city (JP); ADVICS CO., LTD., Kariya-city (JP)

(72) Inventor: Fumitoshi KOYAMA, Kariya-shi (JP)

(21) Appl. No.: 14/324,491

(22) Filed: Jul. 7, 2014

(30) Foreign Application Priority Data
Jul. 8, 2013 (JP) 2013-142414

(51) Int. Cl. F16J 15/10

(52) U.S. Cl. CPC F16J 15/10
USPC 277/641

(57) ABSTRACT

A sealing arrangement includes a first member having a non-circular hole, a second member having a non-circular and annular groove that extends continuously around an outer circumference of the second member, and a seal made of an elastic material and seated in the groove. An outer circumference of a body of the seal is in contact with a wall of the first member defining the non-circular hole, and an inner circumference of the body of the seal is in contact with a wall of the second member defining the groove. At least one protrusion protrudes from at least one portion of the body where a relatively low contact pressure is applied between the body and the groove and along a direction of insertion of the second member into the first member.

### CROSS-REFERENCE TO RELATED APPLICATION

This application is based on and claims the benefit of priority from earlier Japanese Patent Application No. 2013-142414 filed Jul. 8, 2013, the description of which is incorporated herein by reference.

BACKGROUND

1. Technical Field

The present invention relates to a sealing arrangement including a seal made of an elastic material and adapted to seal between two members.

2. Related Art

A known technique, as disclosed in Japanese Utility Model Publication No. 7-37845, employs a circular seal made of an elastic material (referred to as an O-ring) to seal between a first member including a circular hole formed therein and a second member inserted in the hole of the first member.

In the disclosed sealing arrangement, when the circular seal is seated in a groove of the second member, a contact pressure between an inner circumference of the circular seal and the second member is substantially uniform around the entire inner circumference of the seal, where the entire inner circumference of the seal is in contact with the second member.

It is possible to envisage another sealing arrangement including a non-circular seal J7 that is formed of two straight portions J700 and two arc-like portions J701 connecting the two straight portions J700 at their ends as shown in FIGS. 9 and 10. When the non-circular seal J7 is seated in a groove 361 of the second member J6, no contact pressure is applied between an inner circumference of each straight portion J700 and the second member J6, that is, the inner circumference of each straight portion J700 is not in contact with the second member J6, while a higher contact pressure is applied between an inner circumference of each arc-like portion 3701 and the second member 36.

Hence, during insertion of the assembly of the second member 36 and the seal 37 seated in the groove 361 of the second member 36 into an non-circular hole 311 of the first member 31, an outer circumference of each straight portion J700 of the seal J7 is in contact with a wall 3110 of the first member 31 defining the hole J11 and may thereby be twisted while each arc-like portion J701 remains untwisted as relatively high contact pressure is applied between the inner circumference of each arc-like portion 3701 and the second member J6. Thus, the straight portions 3700 and the arc-like portions 3701 are differently twisted therebetween, which leads to reduction in sealability between the first member 31 and the second member 36.

In consideration of the foregoing, exemplary embodiments of the present invention are directed to providing a sealing arrangement including a non-circular seal, capable of preventing reduction in sealability between two members.

### SUMMARY

In accordance with an exemplary embodiment of the present invention, there is provided a sealing arrangement including: a first member having a non-circular hole formed therein; a second member having a non-circular and annular groove that extends continuously around an outer circumference of the second member; and a seal made of an elastic material and seated in the groove to seal between the first member and the second member. The seal includes a non-circular and annular body such that an outer circumference of the body is in contact with a wall of the first member defining the non-circular hole of the first member and an inner circumference of the body is in contact with a wall of the second member defining the groove. The seal further includes at least one protrusion protruding from at least one portion of the body where a relatively low contact pressure is applied between the body and the groove of the second member and along a direction of insertion of the second member into the first member.

During insertion of the second member into the first member, a twisting force may be applied to a portion of the body of the seal where a relatively low contact pressure is applied between the body of the seal and the groove of the second member. With the above configuration, the protrusion will come into contact with the wall of the first member defining the non-circular hole of the first member during the insertion of the second member into the first member, which can prevent the portion of the seat from being twisted. This can prevent reduction in sealability between the first and second members.

### BRIEF DESCRIPTION OF THE DRAWINGS

FIG. 1 is a front view of a brake fluid pressure control unit to which a sealing arrangement is applied in accordance with one embodiment of the present invention;

FIG. 2 is a bottom view of the brake fluid pressure control unit shown in FIG. 1;

FIG. 3 is a front view of a cap shown in FIG. 1;

FIG. 4 is a cross-sectional view of the cap shown in FIG. 3 taken along line A-A;

FIG. 5 is a top view of the cap shown in FIG. 3;

FIG. 6 is a top view of the a seal shown in FIG. 1;

FIG. 7 is a cross-sectional view of the seal shown in FIG. 6 taken along line C-C;

FIG. 8 is a partial cross-sectional view of principle parts of the sealing arrangement shown in FIG. 3;

FIG. 9 is a cross-sectional view of assembly of a second member and a seal in a sealing arrangement in accordance with the prior art; and

FIG. 10 is a partial cross-sectional view of the sealing arrangement shown in FIG. 9 taken along line D-D.

### DESCRIPTION OF SPECIFIC EMBODIMENTS

In the following detailed description, reference is made to the accompanying drawings that show, by way of illustration, specific embodiments in which the present invention may be implemented. These embodiments are described in sufficient detail to enable those skilled in the art to implement the present invention. It is to be understood that the various embodiments of the present invention, although different from one another, are not necessarily mutually exclusive. For example, a particular feature, structure, or characteristic described herein in connection with one embodiment may be implemented within other embodiments without departing from the spirit and scope of the present invention. In addition, it is to be understood that the location or arrangement of individual elements within each disclosed embodiment may be modified without departing from the spirit and scope of the present invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

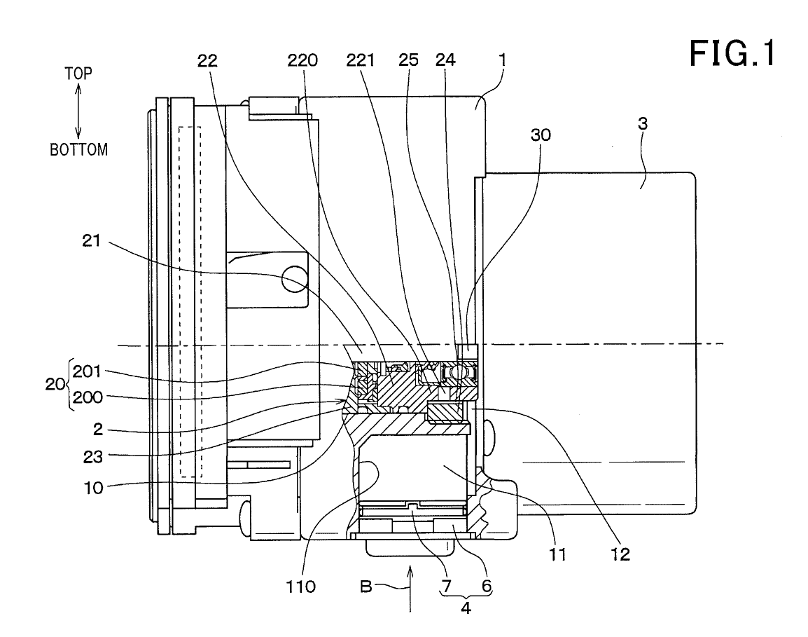

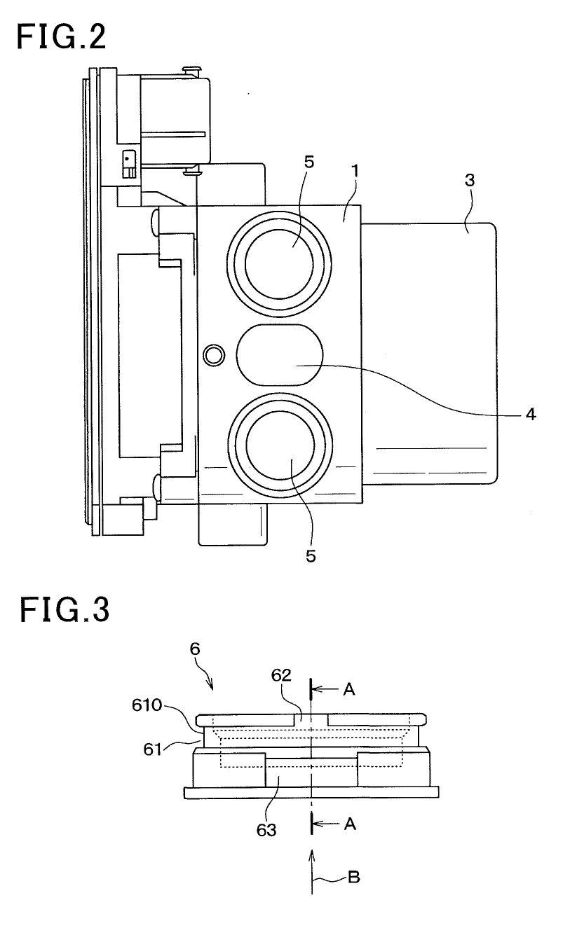

Referring to FIGS. 1 and 2, a brake fluid pressure control unit of the present invention includes a housing 1 as a first member, a pumping system 2 to pressurize a brake fluid and discharge the pressurized brake fluid, an electrical motor 3 to drive a pump 20 of the pumping system 2, a seal assembly 4 to close a brake fluid reservoir 11 for storing the brake fluid, a reservoir 5 to transiently store the brake fluid expelled from hydraulic wheel cylinders (not shown), a plurality of solenoid valves (not shown) to open and close a brake fluid passage through which the brake fluid flows, and an electronic control unit (not shown) to control the operations of the electrical motor 3 and the solenoid valves and others. The brake fluid pressure control unit is mounted to a vehicle such that the vertical direction of FIG. 1 corresponds to the top and bottom direction.

The housing 1 is substantially a cuboid in shape and is made of an aluminium alloy, and includes many brake fluid passages through which the brake fluid flows. The housing 1 has six ports connected to the brake fluid passages on its surface. More specifically, four ports are connected to hydraulic wheel cylinders respectively associated with four wheels of the vehicle and two ports are connected to a master cylinder (not shown) of the vehicle.

The housing 1 includes a pump housing chamber 10 formed therein, with a cylindrical hole shaped space extending horizontally with one end open and the other end closed. The pump housing chamber 10 contains a pumping system 2 (as described later).

Two reservoirs 5 are provided at the bottom of the housing 1, between which a brake fluid reservoir 11 is provided for storing the brake fluid escaping the pumping system 2. The brake fluid reservoir 11 is a non-circular hole. More specifically, the brake fluid reservoir 11 is rounded oblong as viewed along the vertical direction. That is, the brake fluid reservoir 11 looks like an athletics track as viewed along the vertical direction. An inner wall 110 of the housing 1 defining the brake fluid reservoir 11 is hereinafter referred to as a brake fluid reservoir wall 110.

The housing 1 includes a brake fluid-conducting passage 12 formed therein, which directs the brake fluid escaping from the pumping system 2 into the pump housing chamber 10 to the brake fluid reservoir 11.

The electrical motor 3 is disposed at one end of the housing 1 so as to close an opening of the pump housing chamber 10. One end portion of a drive shaft 30 of the electrical motor 3 emerges in the pump housing chamber 10.

The pump 20 is a trochoid pump that includes an outer rotor 200 having inner teeth around its inner circumference and an inner rotor 201 having outer teeth around its outer circumference. The drive shaft 21 is inserted in a hole of the inner rotor 201 and keyed to the inner rotor 201. The drive shaft 21 of the pumping system 2 engages with the drive shaft 30 of the electrical motor 3. The pump 20 is driven by the electrical motor 3 via the drive shaft 21.

The inner teeth of the outer rotor 200 and the outer teeth of the inner rotor 201 are engaged with each other to form a plurality of voids between the outer rotor 200 and the inner rotor 201. Each void expands or contracts in conjunction with rotation of the drive shaft 21, which leads to inhalation or expiration of the brake fluid.

A casing of the pumping system 2 is defined by first and second cylinders 22, 23 and others. The pump 20 is disposed within a rotor chamber between the first and second cylinders 22, 23. The assembly of the casing and the pump 20 and others is inserted in the pump housing chamber 10 of the housing 1. A ring-shaped external thread 24 is screwed into an entrance portion of the pump housing chamber 10, whereby the pumping system 2 is secured to the housing 1.

A cylindrical tube 220 of the first cylinder 22 has at least one through-hole 221, one of which is located at the lowermost portion of the cylindrical tube 220.

A clearance 25 is provided between the cylindrical tube 220 and the external thread 24, via which clearance the through-hole 221 and the brake fluid-conducting passage 12 can be in fluid communication with each other.

The brake fluid escaping from the pumping system 2 into the pump housing chamber 10, more specifically, the brake fluid escaping from the pump 20 into a space within the cylindrical tube 220 via a clearance between the casing and the drive shaft 21, will be directed to the brake fluid reservoir 11 via the through-hole 221, the clearance 25 and the brake fluid-conducting passage 12 in this order. The seal assembly 4 includes a cap 6 (as a second member) for closing the brake fluid reservoir 11 and a seal 7 for sealing between the housing 1 and the cap 6.

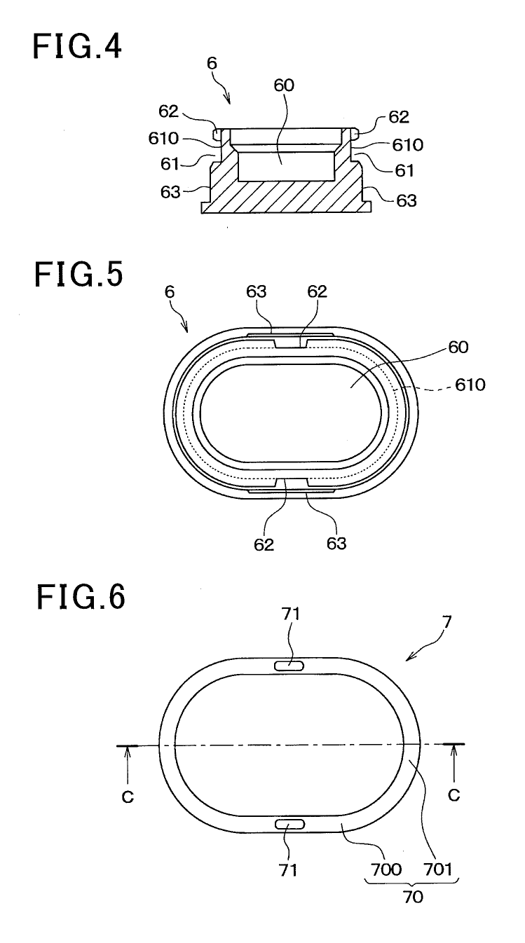

As shown in FIGS. 3 to 5, the cap 6 is made of an aluminium alloy and rounded oblong as viewed along the vertical direction, that is, along the top and bottom direction. That is, the cap 6 looks like an athletics track as viewed along the vertical direction.

The cap 6 has a recess 60 in communication with the brake fluid reservoir 11 for storing the brake fluid escaping the pumping system 2.

The cap 6 has a non-circular groove 61 formed on the outer circumference thereof, in which the seal 7 is seated. The groove 61 is rounded oblong in shape as viewed along the vertical direction. That is, the groove 61 looks like an athletics track formed of two straight portions and two arc-like portions connecting the two straight portions at their ends as viewed along the vertical direction. An outer wall 610 of the groove 61 of the cap 6 is hereinafter referred to as a groove wall 610.

The cap 6 includes two notches 62 formed on its outer circumference for engagement with two protrusions 71 (described later) of the seal 7. The two notches 62 are positioned along the respective straight portions of the groove 61 and on the cap insertion direction B side of the groove 61 (that is, on the upper side of the groove 61 in FIG. 3).

The cap 6 includes two bulges 63 formed on its outer circumference for digging into the brake fluid reservoir wall 110, which allows the cap 6 to be press fit into the brake fluid reservoir 11 along the cap insertion direction B and thereby be secured to the aperture of the brake fluid reservoir 11.

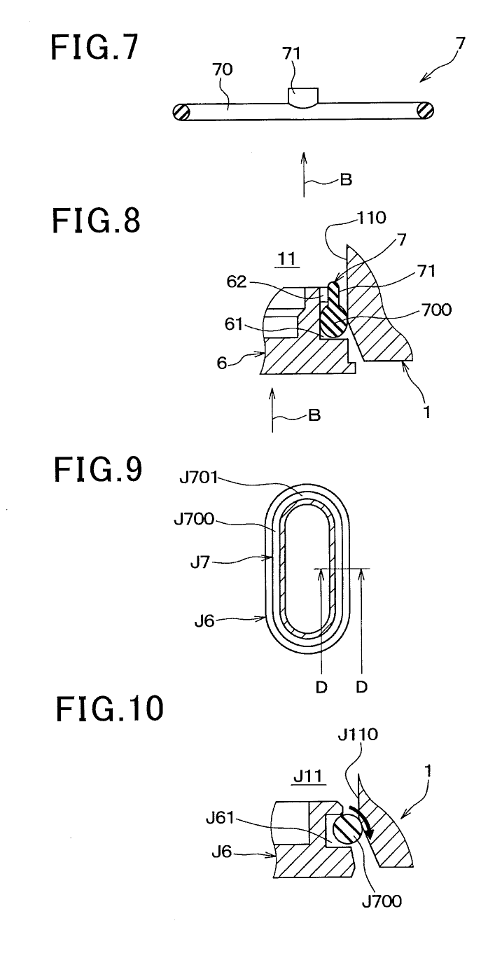

As shown in FIGS. 6 and 7, the seal 7 made of an elastic material, such as ethylene propylene diene monomer (EPDM), includes a non-circular and annular body 70 (also referred to as a seal body).

The seal body 70 is formed of two straight portions 700 in parallel with each other and two arc-like portions 701 connecting the two straight portions 700 at their ends. The seal body 70 is rounded oblong in shape as viewed along the vertical direction. That is, the seal body 70 looks like an athletics track as viewed along the vertical direction. The outer circumference of the seal body 70 is in contact with the brake fluid reservoir wall 110 while the inner circumference of the seal body 70 is in contact with the groove wall 610.

Before insertion of the cap 6 having the seal 7 seated in the groove 61 of the cap 6 into the brake fluid reservoir 11, the contact pressure between the straight portion 700 and the groove wall 610 is lower than the contact pressure between the arc-like portion 701 and the groove wall 610.

Each straight portion 700 has a protrusion 71 protruding along the cap insertion direction B. More specifically, for each of the two straight portions 700, the protrusion 71 is provided on the cap insertion direction B side of the straight portion 700 (i.e., on the upper side of the straight portion 700 in FIG. 7).

The assembly of the cap 6 and the seal 7 into the housing 1 will now be explained with reference to FIG. 8.

The seal 7 is seated in the groove 61 such that the protrusions 71 are engaged with their respective notches 62. The engagement of the protrusions 71 with the notches 62 can prevent the seal 7 from rotating around the cap 6 along the circumferential direction of the seal 7.

Without the protrusions 71, the rounded oblong seal 7, however, would be deformed in shape during the circumferential rotation of the seal 7 around the cap 6, which would give rise to differences in contact pressure between the portions of the seal 7. This would lead to reduction in sealability between the housing 1 and the cap 6. In the present embodiment, the circumferential rotation of the seal 7 around the cap 6 can be prevented, which can lead to the reduction in sealability.

Subsequently, during insertion of the assembly of the cap 6 and the seal 7 into the brake fluid reservoir 11, twisting forces may be applied to the portions of the seal 7. Particularly, the straight portions 700 of the seal 7 are apt to be twisted due to relatively lower contact pressures applied to the straight portions 700. In the present embodiment, the protrusions 71 may come into contact with the brake fluid reservoir wall 110 during the insertion of the assembly of the cap 6 and the seal 7 into the brake fluid reservoir 11, thereby preventing the straight portions 700 from being twisted. Prevention of the twisting of the seal 7 may lead to reduction in sealability between the housing 1 and the cap 6.

Thereafter, the assembly of the cap 6 and the seal 7 is inserted into the brake fluid reservoir 11 to a predetermined position where the seal 7 is in contact with the brake fluid reservoir wall 110. This can provide sealing between the housing 1 and the cap 6.

In the brake fluid pressure control unit configured as above, the pump 20 is driven by the electrical motor 3, for example, during the antilock brake system (ABS) control and/or the traction control, to thereby intake, pressurize and discharge the brake fluid.

When the pump 20 is operating, a small amount of the brake fluid may escape from the pump 20 into the space inside the cylindrical tube 220 via the clearance between the casing of the pumping system 2 and the drive shaft 21. The brake fluid escaping from the pump 20 into the space within the cylindrical tube 220 is directed to the brake fluid reservoir 11 via the through-hole 221, the clearance 25 and the brake fluid-conducting passage 12 in this order and then stored or accumulated in the brake fluid reservoir 11 and the recess 60.

In the present embodiment, as described above, the circumferential rotation of the seal 7 around the cap 6 during assembling the seal 7 to the cap 6 can be prevented, thereby preventing reduction in sealability. In addition, the twisting of the straight portions 700 during inserting the assembly of the seal 7 and the cap 6 into the housing 1 can be prevented, thereby preventing reduction in sealability.

### Other Embodiments

In the above embodiment, the notches 62 are disposed on the cap insertion direction B side of the groove 61, and the protrusions 71 are disposed on the cap insertion direction B side of the straight portions 700 of the seal body 70. Alternatively, the notches 62 may be disposed on the anti-cap insertion direction B side of the groove 61, and the protrusions 71 may be disposed on the anti-cap insertion direction B side of the straight portions 700 of the seal body 70.

In the above embodiment, the seal 7 has the body 70 that looks like an athletics track as viewed along the vertical direction. Alternatively, the seal 7 may have a body that looks like an ellipse or a rectangle (but having round corners) as viewed along the vertical direction.

In the above embodiment, the sealing arrangement is applied to the brake fluid pressure control unit. Alternatively, the sealing arrangement may be applied to any other fluid unit.

What is claimed is:

1. A sealing arrangement comprising:
a first member having a non-circular hole formed therein;
a second member having a non-circular and annular groove extending continuously around an outer circumference of the second member; and
a seal made of an elastic material and seated in the groove to seal between the first member and the second member,
wherein the seal comprises:
a non-circular and annular body, an outer circumference of the body being in contact with a wall of the first member defining the non-circular hole of the first member and an inner circumference of the body being in contact with a wall of the second member defining the groove; and
at least one protrusion protruding from at least one portion of the body where a relatively low contact pressure is applied between the body and the groove of the second member and along a direction of insertion of the second member into the first member.

2. The sealing arrangement of claim 1, wherein the body of the seal comprises two straight portions seated in the groove on opposite sides of the second member and two arc-like portions connecting the two straight portions at their ends, and each of the at least one protrusion protrudes from either one of the two straight portions of the body.

3. The sealing arrangement of claim 1, wherein the second member comprises at least one notch, one for each protrusion of the seal, each configured to engage with a corresponding protrusion of the seal.

4. The sealing arrangement of claim 2, wherein
the at least one protrusion comprises a plurality of the protrusions, one of the protrusions protruding from one of the two straight portions and another of the protrusions protruding from the other of the two straight portions.
